(19) United States
(12) Patent Application Publication
(10) Pub. No.: US 2018/0211291 A1
(43) Pub. Date: Jul. 26, 2018

(54) Generating Dynamic Computer Data Structures for Automatic Adjustment of Bids for Online Advertisements

(71) Applicant: Criteo SA, Paris (FR)

(72) Inventors: Cédric Chanal, Paris (FR); Manu Cupcic, Paris (FR); Céline Montheard, Paris (FR); Pascal Pons, Palo Alto, CA (US)

(21) Appl. No.: 15/415,741

(22) Filed: Jan. 25, 2017

(51) Int. Cl. G06Q 30/02; G06F 17/30

(52) U.S. Cl. CPC G06Q 30/0277; G06F 17/30864

(57) ABSTRACT

A memory module of a first computing device is configured according to a data structure representing a matrix of remarketing lists comprising a series of ranges of bid adjustment values and a series of membership duration values. Each cell in the table is associated with a remarketing list. The first computing device coalesces the matrix of remarketing lists into a series of logical remarketing lists by selecting the remarketing lists associated with one or more logical columns of the matrix and combining the selected remarketing lists into a logical remarketing list. The first computing device calls an API to transmit instructions to a remote computing device that include a representation of the series of logical remarketing lists and a representation of the matrix of remarketing lists, and enable the remote computing device to replicate the series of logical remarketing lists and the matrix of remarketing lists in a memory module.

### TECHNICAL FIELD

The present technology relates to methods and systems for generating dynamic computer data structures for automatic adjustment of bids for online advertisements.

### BACKGROUND

As Internet users interact with various websites (e.g., visiting pages, viewing and purchasing products) via their computing devices, the websites are typically configured to record data about the user's activity by the use of techniques such as tracking cookies, tags, pixels, and the like that are downloaded to the user's computing device and/or embedded in the webpage. Website computing devices are configured to analyze the recorded data for user trends, preferences, and actions which can be leveraged when presenting computerized advertisements to the user via other webpages at a future time (also called remarketing). One example of this is Google AdWords™, which provides remarketing tags for advertisers to insert into their webpages. Generally, the remarketing tags operate to identify users and insert the users into appropriate remarketing lists using a set of defined rules that are matched against attributes of the user's web activity (e.g., URLs that a user has accessed, referral URLs, interaction performed by the user, other parameters).

Publisher computing systems can provide webpages or other online content (e.g., search functionality) that can also include one or more display opportunities for computerized advertisements (e.g., space for a banner or textual advertisement across the top of the webpage) that include or refer to one or more items (e.g., consumer goods or products) that may be of interest to a viewer of the advertisement display. When such webpages are loaded, the publisher computing system communicates with one or more ad systems to generate the advertisement source code to be inserted into the display opportunities on the webpage. For certain applications, the ad system can reference the user's prior activity (as recorded by the techniques described above) and determine that a certain product can be remarketed to the user—potentially increasing the chance that the user interacts with the advertising display (e.g., clicks on the ad and/or purchases a product presented in the ad). As part of this process, the ad system typically generates or requests bids from various advertisers who may wish to select the display opportunity for presentation of a remarketing ad to the user.

In some instances, such as Google AdWords™, the advertiser (or advertiser's agent) preconfigures the bid structure by defining specific remarketing lists according to certain criteria, associating the remarketing lists to certain ad groups, and assigning a particular bid adjustment to each ad group. For example, an advertiser may configure a remarketing list with rules such that any user that accesses a particular URL is assigned to the remarketing list and, when users from that remarketing list are shown an ad via the publisher website, the advertiser's bid for the ad is adjusted based upon the bid adjustment assigned to the remarketing list. In this way, advertisers are able to indicate via the bid adjustments whether they are willing to pay more (or less) than the max CPC of a criterion, when an ad is shown to a user from a given remarketing list.

Also, remarketing lists are generally configured to have specific membership durations, typically expressed in days, after which users are removed from the lists. For example, if a remarketing list has a membership duration of one day, users who were inserted into that list more than one day ago are removed. In some systems, the maximum membership duration limit is 540 days.

However, certain publisher systems require a minimum amount of user identifiers to be assigned to each remarketing list (e.g., Google AdWords™ lists that target advertising opportunities on Google search results must have a minimum of one thousand active users). If a remarketing list does not have the minimum amount of users, the publisher system typically will determine that the remarketing list is not eligible and so the bid adjustment associated with the list is not used when generating advertisements—which generally results in a bid adjustment that is different from the optimal adjustment for a given advertising opportunity.

### SUMMARY

Accordingly, there is a need for technology that works within the existing limits of such publisher system remarketing list structures in order to realize a more efficient and optimized process for selecting bid adjustments in remarketing advertisement opportunities. The techniques presented herein provide an advantageous methodology for configuring computer memory according to specific data structures that enable advertisers to set up a matrix of logical remarketing lists that both meet the minimum user requirements of the publisher computing systems and also realize the optimal bid adjustment for a particular advertising opportunity.

In one aspect, there is a computerized method. A memory module of a first computing device is configured according to a data structure representing a matrix of remarketing lists comprising a series of ranges of bid adjustment values and a series of membership duration values. The data structure includes a table comprised of a plurality of logical columns each associated with a range of bid adjustment values of the series of ranges of bid adjustment values and a plurality of logical rows each associated with a membership duration value of the series of membership duration values. Each cell in the table is associated with a remarketing list comprised of a plurality of user identifiers. The first computing device coalesces the matrix of remarketing lists into a series of logical remarketing lists by selecting the remarketing lists associated with one or more logical columns of the matrix of remarketing lists and combining the selected remarketing lists into a logical remarketing list comprised of the plurality of user identifiers from each of the selected remarketing lists. The first computing device calls an application programming interface (API) to transmit instructions to a remote computing device, wherein the instructions include a representation of the series of logical remarketing lists and a representation of the matrix of remarketing lists, and enable the remote computing device to replicate the series of logical remarketing lists and the matrix of remarketing lists in a memory module of the remote computing device. The remote computing device uses the instructions to adjust one or more bids.

In another aspect, there is a system. The system comprises a first computing device having a memory module, and a remote computing device having a memory module. The memory module of the first computing device is configured according to a data structure representing a matrix of remarketing lists comprising a series of ranges of bid adjustment values and a series of membership duration values. The data structure includes a table comprised of a plurality of logical columns each associated with a range of bid adjustment values of the series of ranges of bid adjustment values and a plurality of logical rows each associated with a membership duration value of the series of membership duration values. Each cell in the table is associated with a remarketing list comprised of a plurality of user identifiers. The first computing device is configured to coalesce the matrix of remarketing lists into a series of logical remarketing lists by selecting the remarketing lists associated with one or more logical columns of the matrix of remarketing lists and combining the selected remarketing lists into a logical remarketing list comprised of the plurality of user identifiers from each of the selected remarketing lists. The first computing device is configured to call an application programming interface (API) to transmit instructions to the remote computing device, wherein the instructions include a representation of the series of logical remarketing lists and a representation of the matrix of remarketing lists, and enable the remote computing device to replicate the series of logical remarketing lists and the matrix of remarketing lists in a memory module of the remote computing device. The remote computing device uses the instructions to adjust one or more bids.

Any of the above aspects can include one or more of the following features. In some embodiments, a first logical column of the plurality of logical columns in the table is associated with the highest bid adjustment value in the series of ranges of bid adjustment values and a second logical column of the plurality of logical columns in the table is associated with the lowest bid adjustment value in the series of ranges of bid adjustment values. In some embodiments, each logical column between the first logical column and the second logical column is associated with a decreasing range of bid adjustment values in the series of ranges of bid adjustment values. In some embodiments, the first logical column is a rightmost column and the second logical column is a leftmost column.

In some embodiments, a first row of the plurality of logical rows in the table is associated with the smallest membership duration value in the series of membership duration values and a second row of the plurality of logical rows in the table is associated with the largest membership duration value in the series of membership duration values. In some embodiments, each logical row between the first logical row and the second logical row is associated with an increasing membership duration value in the range of membership duration values. In some embodiments, the first logical row is a topmost row and the second logical row is a bottommost row.

In some embodiments, a first logical remarketing list of the series of logical remarketing lists comprises the remarketing lists associated with the cells of the logical column in the table associated with a highest range of bid adjustment values. In some embodiments, a last logical remarketing list of the series of logical remarketing lists comprises the remarketing lists associated with the cells of all of the logical columns in the table. In some embodiments, each of the logical remarketing lists of the series of logical remarketing lists between the first logical remarketing list and the last logical remarketing list comprises the remarketing lists associated with the cells of a subset of all the logical columns in the table. In some embodiments, each of the logical remarketing lists of the series of logical remarketing lists between the first logical remarketing list and the last logical remarketing list comprises the remarketing lists of the preceding logical remarketing lists in the series of logical remarketing lists and the remarketing lists associated with the cells of the logical column in the table associated with the next range of bid adjustment values in the series of ranges of bid adjustment values.

In some embodiments, the user identifiers in each remarketing list correspond to users that initiated an event relating to an advertiser website. In some embodiments, the event includes one or more of: a search, an add-to-cart action, a conversion, an addition of a product to a list of favorites, and a page visit. In some embodiments, the page visit includes one or more of: a home page visit, a product page visit, and a category page visit.

In some embodiments, an assignment of a user identifier to a remarketing list depends upon one or more prior events relating to an advertiser website, the prior events being initiated by a user associated with the user identifier. In some embodiments, the computing device generates a pixel that initiates insertion of the user identifiers in each remarketing list, the computing device transmits the pixel to the advertiser website, the advertiser website embeds the pixel in a webpage of the advertiser website, the advertiser website transmits the user identifier of the user that initiated an event relating to at least one of: the webpage and the advertiser website, to a remote computing device, and the remote computing device stores the user identifier in the matrix of remarketing lists in the memory module.

In some embodiments, the one or more bids are for an advertising opportunity associated with search results. In some embodiments, each value in the series of membership duration values corresponds to a duration during which one or more user identifiers are included in an associated remarketing list. In some embodiments, a difference between the values in a first portion of the series of membership values is smaller than a difference between the values in a second portion of the series of membership values. In some embodiments, the duration is a number of days. In some embodiments, the series of membership duration values ranges from 1 day to 180 days. In some embodiments, the series of membership duration values ranges from 1 day to 540 days.

Other aspects and advantages of the present technology will become apparent from the following detailed description, taken in conjunction with the accompanying drawings, illustrating the principles of the technology by way of example only.

### BRIEF DESCRIPTION OF THE DRAWINGS

The foregoing and other objects, features, and advantages of the present technology, as well as the technology itself, will be more fully understood from the following description of various embodiments, when read together with the accompanying drawings, in which:

FIG. 1 is a diagram of a networked system in accordance with embodiments of the technology.

FIG. 2 is a flow diagram of a method for generating a matrix of remarketing lists.

FIG. 3 depicts an exemplary configuration of the matrix of remarketing lists data structure.

FIG. 4 depicts the matrix of remarketing lists indicating placement of a user identifier in the matrix.

FIG. 5 depicts an exemplary configuration of logical remarketing lists.

FIG. 6 is a flow diagram of a method for populating the remarketing lists used in the matrix of remarketing lists.

### DETAILED DESCRIPTION

Although the technology is illustrated and described herein with reference to specific embodiments, the technology is not intended to be limited to the details shown. Various modifications can be made in the details within the scope of the claims and without departing from the technology.

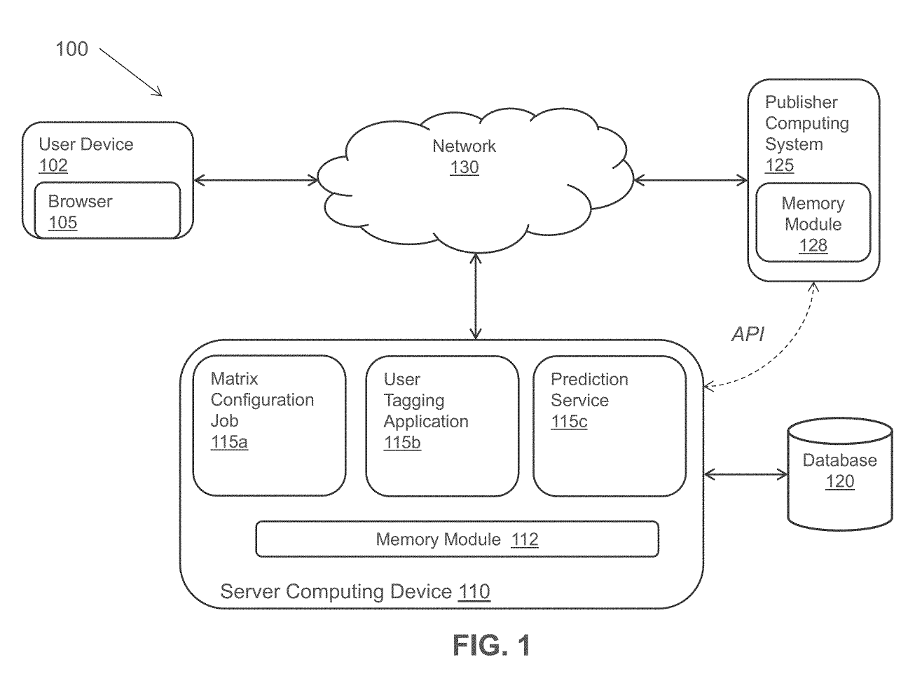

FIG. 1 is a diagram of networked system 100 in accordance with embodiments of the technology. As illustrated, networked system 100 can include user device 102, server computing device 110, database 120, and publisher computing system 125. User device 102, server computing device 110, database 120, and publisher computing system 125 can be in data communication via network 130. User device 102 can be any computing device. In some embodiments, user device 102 can be a mobile computing device (e.g., cellular phones and/or tablets), a PC, or other computing device. User device 102 executes web browser 105.

Server computing device 110 is a device including specialized hardware and/or software modules that execute on a processor and interact with memory modules (e.g., memory module 112) of server computing device 110, to receive data from other components of the system 100, transmit data to other components of the system 100, and perform other functions as described herein. Server computing device 110 includes several computing modules 115a, 115b, and 115c that execute on one or more processors of server computing device 110. In some embodiments, modules 115a, 115b, and 115c are specialized sets of computer software instructions programmed onto one or more dedicated processors in server computing device 110 and can include specifically-designated memory locations and/or registers for executing the specialized computer software instructions.

Although the modules 115a, 115b, and 115c are shown in FIG. 1 as executing within the same server computing device 110, in some embodiments the functionality of modules 115a, 115b, and 115c can be distributed among a plurality of server computing devices. As shown in FIG. 1, the server computing device 110 enables modules 115a, 115b, and 115c to communicate with each other in order to exchange data for the purpose of performing the described functions. It should be appreciated that any number of computing devices, arranged in a variety of architectures, resources, and configurations (e.g., cluster computing, virtual computing, cloud computing) can be used without departing from the scope of the invention. The exemplary functionality of modules 115a, 115b, and 115c is described in detail below.

Server computing device 110 is coupled to database 120. Database 120 is a computing device (or in some embodiments, a set of computing devices) coupled to server computing device 110 and is configured to receive, generate, and store specific segments of data relating to the processes described herein. In some embodiments, all or a portion of database 120 can be integrated with server computing device 110 or be located on a separate computing device or devices. The database 120 can comprise one or more databases (e.g., including data structures, tables, schema, and the like) configured to store portions of data used by the other components of the system 100, as will be described in greater detail below.

Publisher computing system 125 can be any computing device, such as a server or multiple servers. In some embodiments, publisher computing system 125 can serve webpages to browser 105 on user device 102. In some embodiments, publisher computing system 125 can insert advertisements into the webpages served to the browser 105 on user device 102, such as search engine results webpages, using one or more logical remarketing lists associated with an advertiser and as configured in a memory module of the publisher computing system 125.

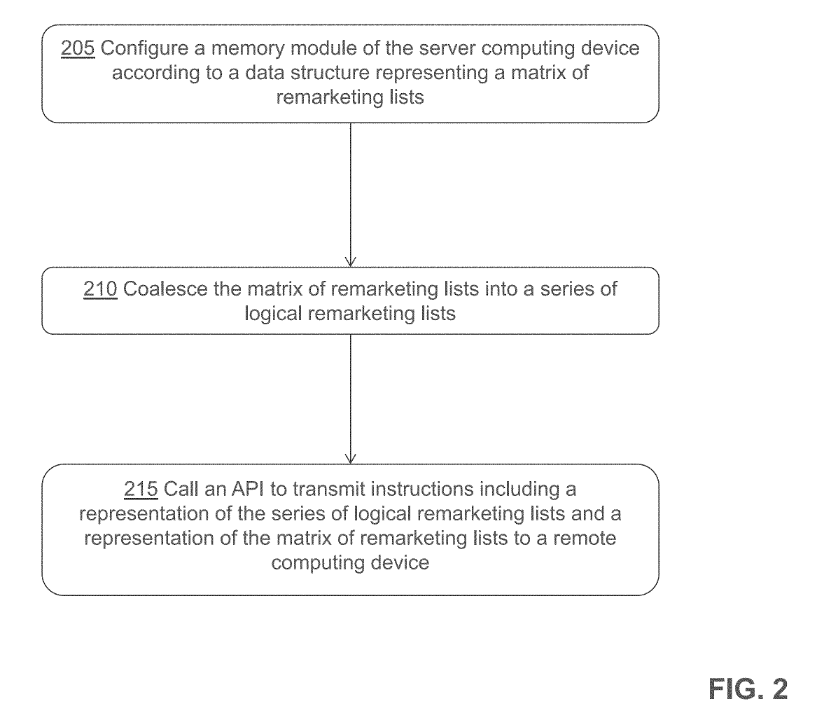

FIG. 2 is a flow diagram of a method for generating remarketing lists, using the system 100 of FIG. 1. At step 205, the matrix configuration job 115a executing on server computing device 110 configures a memory module 112 device according to a data structure representing a matrix of remarketing lists comprising a series of ranges of bid adjustment values and a series of membership duration values. The data structure includes a table comprised of: a plurality of logical columns each associated with a range of bid adjustment values of the series of ranges of bid adjustment values, and a plurality of logical rows each associated with a membership duration value of the series of membership duration values. In one embodiment, the matrix configuration job is a Hadoop MapReduce job that is triggered periodically (e.g., every two hours) to generate the matrix of remarketing lists using data that defines the structure of the matrix such as number of rows, number of columns, bid adjustment ranges, and membership durations as stored in, e.g., database 120. The matrix configuration job then makes certain application programming interface (API) calls to the publisher computing system 125 that create the remarketing lists at the publisher computing system 125 and associate the remarketing lists with specific advertising campaigns of the advertiser for the purpose of bidding on electronic advertisements. For example, the publisher computing system 125 can then populate the remarketing lists in certain webpages based upon pixels that are contained within the webpages as created by, e.g., an advertiser.

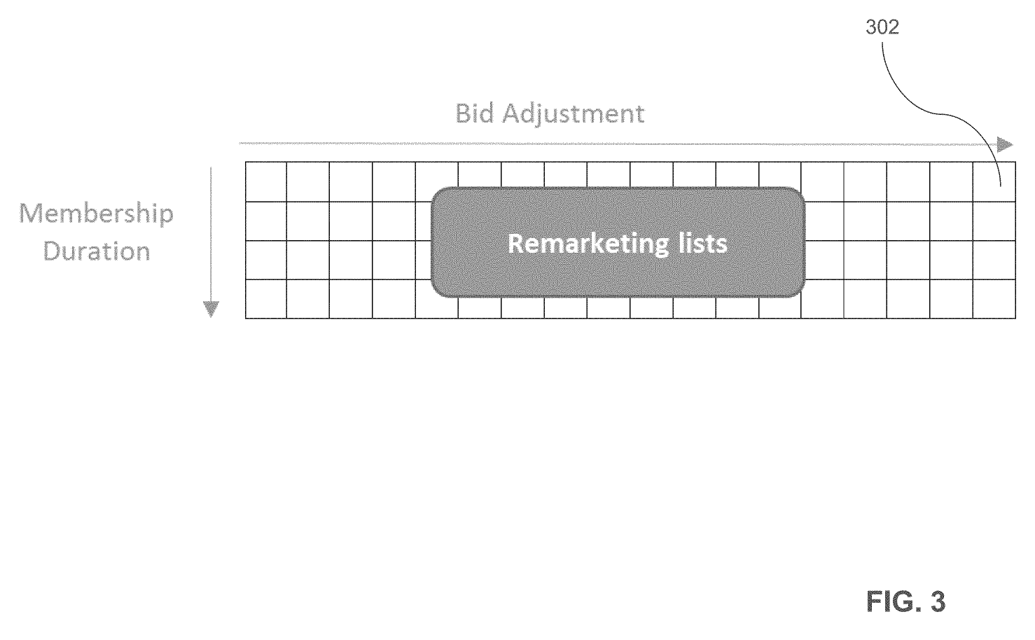

FIG. 3 depicts an exemplary configuration of the matrix of remarketing lists data structure. As shown in FIG. 3, the matrix includes a plurality of columns, where each column corresponds to a range of bid adjustment values, and a plurality of rows, where each row corresponds to a membership duration value. For example, the rightmost column in the matrix can be associated with the highest bid adjustment value, the leftmost column in the matrix can be associated with the lowest bid adjustment value, and each column between the leftmost and rightmost columns can be associated with an increasing range of bid adjustment values. Also, the topmost row in the matrix can be associated with the smallest membership duration value in the series of membership duration values, the bottommost row in the matrix can be associated with the largest membership duration value, and each row between the topmost and bottommost rows can be associated with an increasing membership duration value. In one embodiment, the series of ranges of bid adjustment values can be between −90% and +900% and the membership duration values can be between 1 day and 180 days. In another embodiment, the membership duration values can be between 1 day and 540 days.

Accordingly, each cell in the matrix corresponds to a remarketing list that is assigned a particular range of bid adjustment values and a particular membership duration value. For example, the remarketing list in cell 302 may be assigned a range of bid adjustment values between +850% and +900% and a membership duration value of 1 day. Each remarketing list comprises a plurality of user identifiers (e.g., an ID number that identifies a particular user that interacts with the publisher computing system via a user device).

In one embodiment, the user identifiers in each remarketing list correspond to users that initiated an event relating to an advertiser website—such as a search, an add-to-cart action, a conversion, an addition of a product to a list of favorites, and a page visit, including a home page visit, a product page visit, and/or a category page visit. In some embodiments, assignment of a user identifier to a remarketing list depends upon one or more prior events relating to the advertiser website that were initiated by the user associated with the user identifier.

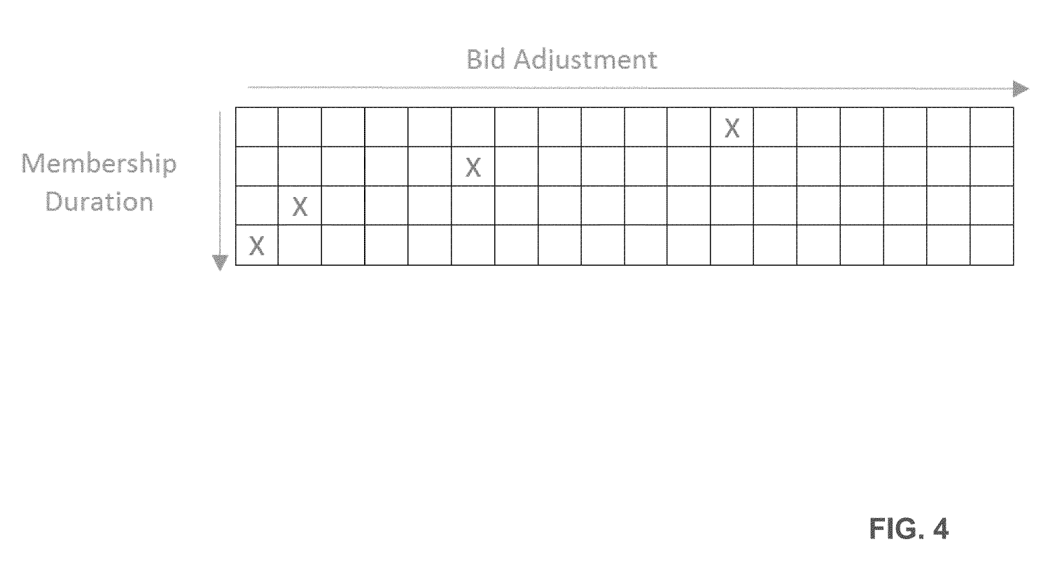

For example, when a user visits a website of the publisher computing system—such as a search engine results page—the publisher computing system generates one or more advertisements to be inserted into the webpage to accompany the content being presented to the user. As part of the advertisement generation process, the publisher computing system can be configured to refer to the remarketing list matrix in order to determine a bid adjustment associated with an advertisement presented to the user. As described previously, the bid adjustment represents a factor by which a bid for the advertising opportunity is adjusted based upon, e.g., a certain remarketing list to which a user is assigned. In some embodiments, each user identifier is placed into one remarketing list per row of the matrix, so that a user is associated with a different bid adjustment range for each membership duration. As an example, FIG. 4 depicts the matrix of remarketing lists including an ‘x’ in certain cells of the matrix. Each ‘x’ corresponds to a remarketing list that contains a user identifier for the same user.

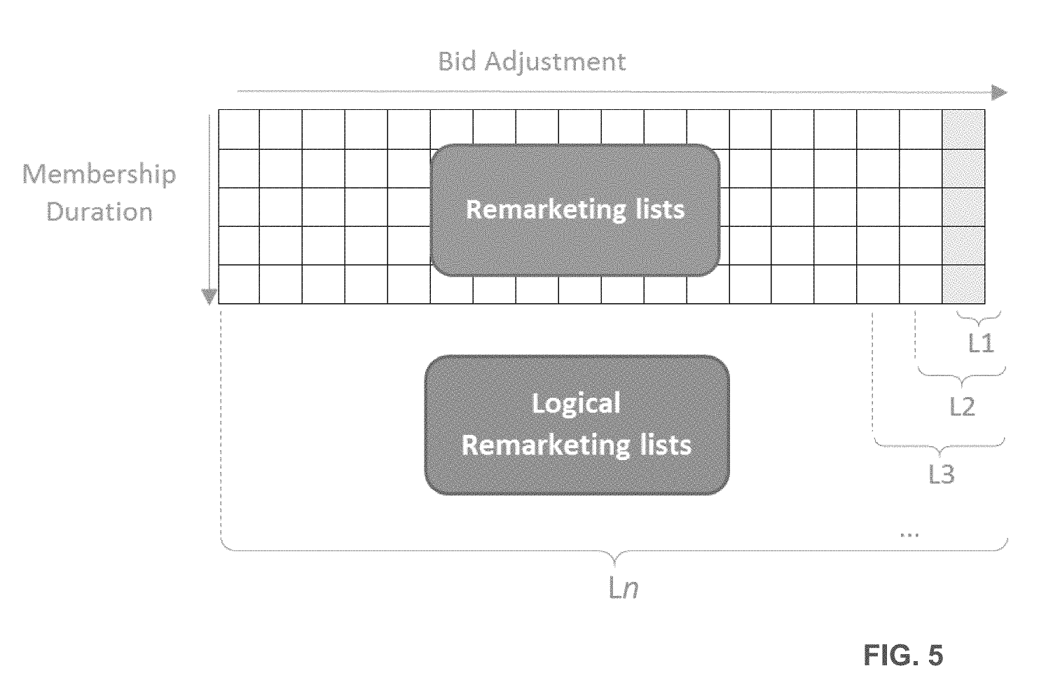

As stated above, certain publisher computing systems may require a minimum number of user identifiers in each remarketing list configured on their systems. In order to overcome this limitation, at step 215 of FIG. 2 the matrix configuration job 115a coalesces the matrix of remarketing lists into a series of logical remarketing lists to be transmitted to the publisher computing system 125. FIG. 5 depicts an exemplary configuration of the logical remarketing lists. As shown in FIG. 5, each of the remarketing lists associated with the rightmost column of the matrix (e.g., the remarketing lists corresponding to the highest bid adjustment range) are coalesced (e.g., using an AND operator) into a single logical remarketing list L1. Similarly, each of the remarketing lists associated with the rightmost two columns of the matrix are coalesced into a single logical remarketing list L2. The matrix configuration job 115a continues coalescing the remarketing lists in this manner—e.g., adding a column of remarketing lists to the next logical list—until the job has generated a series of logical remarketing lists covering the entire matrix. For example, the last logical remarketing list created Ln includes each of the remarketing lists—and therefore, all of the user identifiers—associated with all of the cells in the matrix.

It should be appreciated that a user identifier can appear in multiple logical remarketing lists because that user identifier can be associated with multiple remarketing lists (see FIG. 4). For example, if the publisher computing system 125 uses logical remarketing list L3 in determining a bid adjustment, the system determines that a user identifier appears in list L1, L2, and L3—each appearance corresponding to a certain bid adjustment and membership duration. However, when performing the bid adjustment process described above, the publisher computing system 125 is configured to select the highest bid adjustment for a particular user identifier (for example, the bid adjustment from list L1)—thereby automatically selecting the optimal bid adjustment despite any minimum user restrictions imposed by publisher computing system on the configuration of its remarketing lists.

Once the matrix configuration job 115a has created the series of logical remarketing lists, at step 215 the matrix configuration job calls an API to transmit instructions to the publisher computing system 125 that include a representation of the series of logical remarketing lists and also a representation of the remarketing lists that comprise the matrix. The instructions, when received and processed by the API interface at the publisher computing system, enable the publisher computing system to replicate the matrix of remarketing lists and the series of logical remarketing lists in a memory module (e.g., module 128). The instructions also enable the publisher computing system to associate newly-generated logical remarketing lists with one or more advertising campaigns. In some embodiments, the publisher computing system stores the replicated series of logical remarketing lists in a database (not shown). For example, the API can utilize the SOAP protocol for exchange of messages and other data between the server computing device 110 and the publisher computing system 125 in order to configure the series of logical remarketing lists at the publisher computing system 125.

Once the publisher computing system 125 has replicated the series of logical remarketing lists, the system 125 can use the logical remarketing lists to adjust bids for computerized advertising opportunities as described above.

Another facet of the advantageous methods and systems described herein involves the automatic population and updating of the remarketing lists that make up the matrix over time based upon user interactions with websites. As mentioned above, such user activity can be tracked through the use of source code embedded in certain websites—so that when a user visits and/or interacts with a specific webpage (e.g., URL), the source code transmits a request to the server computing device 110 that analyzes the matrix of remarketing lists, determines the bid adjustment range corresponding to each membership duration in the matrix, and generates a tag (or set of pixels) that, when returned to the requesting website, places the user in each remarketing list associated with the membership duration-bid adjustment range combinations.

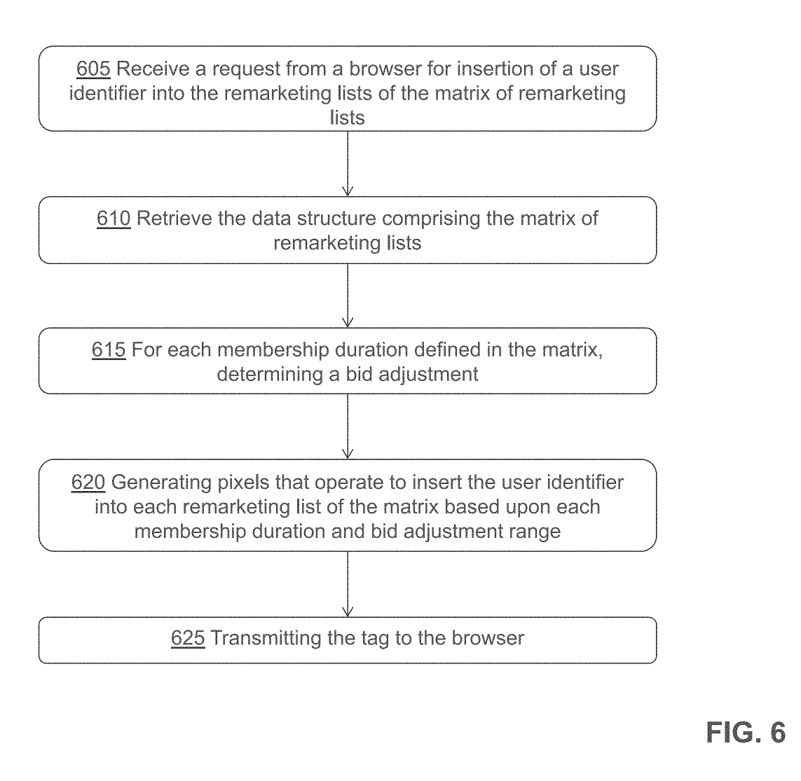

FIG. 6 is a flow diagram of a method for populating the remarketing lists used in the matrix of remarketing lists, using the system 100 of FIG. 1. A user at user device 102 interacts via browser 105 with a webpage served by publisher computing system 125. The webpage includes embedded source code that instructs the browser to transmit a request to the user tagging application 115b on server computing device 110 for insertion of a user identifier for the user into remarketing lists. At step 605, the user tagging application receives the request from the browser. In one embodiment, the user tagging application is a web application using the ASP.NET framework that receives the request and generates pixels to place user identifiers of users into appropriate remarketing lists.

At step 610, the user tagging application 115b retrieves the data structure comprising the matrix of remarketing lists. In some embodiments, the user tagging application retrieves the data structure from memory module 112. In some embodiments, the user tagging application retrieves the data structure from database 120.

For each membership duration value in the matrix data structure, the user tagging application 115b communicates with the prediction service 115c of server computing device 110 to, e.g., compute the relative profitability of a user in a given context (e.g., webpage accessed, user activity history, and the like) and translate the profitability into a bid adjustment (or bid adjustment range). The prediction service 115c transmits the bid adjustment to the user tagging application 115b, which then generates pixels that operate to insert the given user identifier into each remarketing list of the matrix data structure based upon each combination of membership duration and bid adjustment range. As a result, the user identifier is populated into a remarketing list in each row of the matrix, where each of these remarketing lists is associated with a different membership duration and bid adjustment range. At step 625, the user tagging application transmits the pixels to the browser.

In some embodiments, when activated, the pixels cause the user device 102 to communicate with publisher computing system 125 and insert the user identifier for the user in the matrix of remarketing lists as stored by publisher computing system. For example, a pixel embedded in a webpage at publisher computing system 125 can be activated by user device when, e.g., the user device loads the webpage in the browser, the user initiates an event on the webpage, or other similar actions.

The above-described techniques can be implemented in digital electronic circuitry, or in computer hardware, firmware, software, or in combinations of them. The implementation can be as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the technology by operating on input data and generating output. Method steps can also be performed by, and apparatus can be implemented as, special purpose logic circuitry, e.g., an FPGA (field programmable gate array) or an ASIC (application specific-integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer also includes, or be operatively coupled to receive data from or transfer data to, or both, one or more mass storage devices for storing data, e.g., magnetic, magneto-optical disks, or optical disks. Data transmission and instructions can also occur over a communications network. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the above described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The above described techniques can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an example implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact through a communication network. The relationship of client and server arises by virtue of computer programs running on the respective computers and having a client-server relationship to each other.

The technology has been described in terms of particular embodiments. The alternatives described herein are examples for illustration only and not to limit the alternatives in any way. The steps of the technology can be performed in a different order and still achieve desirable results. Other embodiments are within the scope of the following claims.

What is claimed is:

1. A computerized method comprising:
configuring a memory module of a first computing device according to a data structure representing a matrix of remarketing lists comprising a series of ranges of bid adjustment values and a series of membership duration values, the data structure including a table comprised of:
a plurality of logical columns each associated with a range of bid adjustment values of the series of ranges of bid adjustment values, and
a plurality of logical rows each associated with a membership duration value of the series of membership duration values,
wherein each cell in the table is associated with a remarketing list comprised of a plurality of user identifiers;
coalescing, by the first computing device, the matrix of remarketing lists into a series of logical remarketing lists by selecting the remarketing lists associated with one or more logical columns of the matrix of remarketing lists and combining the selected remarketing lists into a logical remarketing list comprised of the plurality of user identifiers from each of the selected remarketing lists; and
calling, by the first computing device, an application programming interface (API) to transmit instructions to a remote computing device, wherein the instructions include a representation of the series of logical remarketing lists and a representation of the matrix of remarketing lists, and enable the remote computing device to replicate the series of logical remarketing lists and the matrix of remarketing lists in a memory module of the remote computing device,
wherein the remote computing device uses the instructions to adjust one or more bids.

2. The method of claim 1, wherein a first logical column of the plurality of logical columns in the table is associated with the highest bid adjustment value in the series of ranges of bid adjustment values and a second logical column of the plurality of logical columns in the table is associated with the lowest bid adjustment value in the series of ranges of bid adjustment values.

3. The method of claim 2, wherein each logical column between the first logical column and the second logical column is associated with a decreasing range of bid adjustment values in the series of ranges of bid adjustment values.

4. The method of claim 3, wherein the first logical column is a rightmost column and the second logical column is a leftmost column.

5. The method of claim 1, wherein a first row of the plurality of logical rows in the table is associated with the smallest membership duration value in the series of membership duration values and a second row of the plurality of logical rows in the table is associated with the largest membership duration value in the series of membership duration values.

6. The method of claim 5, wherein each logical row between the first logical row and the second logical row is associated with an increasing membership duration value in the range of membership duration values.

7. The method of claim 6, wherein the first logical row is a topmost row and the second logical row is a bottommost row.

8. The method of claim 1, wherein a first logical remarketing list of the series of logical remarketing lists comprises the remarketing lists associated with the cells of the logical column in the table associated with a highest range of bid adjustment values.

9. The method of claim 8, wherein a last logical remarketing list of the series of logical remarketing lists comprises the remarketing lists associated with the cells of all of the logical columns in the table.

10. The method of claim 9, wherein each of the logical remarketing lists of the series of logical remarketing lists between the first logical remarketing list and the last logical remarketing list comprises the remarketing lists associated with the cells of a subset of all the logical columns in the table.

11. The method of claim 10, wherein each of the logical remarketing lists of the series of logical remarketing lists between the first logical remarketing list and the last logical remarketing list comprises the remarketing lists of the preceding logical remarketing lists in the series of logical remarketing lists and the remarketing lists associated with the cells of the logical column in the table associated with the next range of bid adjustment values in the series of ranges of bid adjustment values.

12. The method of claim 1, wherein the user identifiers in each remarketing list correspond to users that initiated an event relating to an advertiser website.

13. The method of claim 12, wherein the event includes one or more of: a search, an add-to-cart action, a conversion, an addition of a product to a list of favorites, and a page visit.

14. The method of claim 13, wherein the page visit includes one or more of: a home page visit, a product page visit, and a category page visit.

15. The method of claim 12, wherein an assignment of a user identifier to a remarketing list depends upon one or more prior events relating to an advertiser website, the prior events being initiated by a user associated with the user identifier.

16. The method of claim 12, further comprising:
generating, by the computing device, a pixel that initiates insertion of the user identifiers in each remarketing list;
transmitting, by the computing device, the pixel to the advertiser website;
embedding, by the advertiser website, the pixel in a webpage of the advertiser website;
transmitting, by the advertiser website to the remote computing device, the user identifier of the user that initiated an event relating to at least one of: the webpage and the advertiser website; and
storing, by the remote computing device, the user identifier in the matrix of remarketing lists in the memory module

17. The method of claim 1, wherein the one or more bids are for an advertising opportunity associated with search results.

18. The method of claim 1, wherein each value in the series of membership duration values corresponds to a duration during which one or more user identifiers are included in an associated remarketing list.

19. The method of claim 18, wherein a difference between the values in a first portion of the series of membership values is smaller than a difference between the values in a second portion of the series of membership values.

20. The method of claim 18, wherein the duration is a number of days.

21. The method of claim 20, wherein the series of membership duration values ranges from 1 day to 180 days.

22. The method of claim 20, wherein the series of membership duration values ranges from 1 day to 540 days.

23. A system comprising:
a first computing device having a memory module configured according to a data structure representing a matrix of remarketing lists comprising a series of ranges of bid adjustment values and a series of membership duration values, the data structure including a table comprised of:
a plurality of logical columns each associated with a range of bid adjustment values of the series of ranges of bid adjustment values, and
a plurality of logical rows each associated with a membership duration value of the series of membership duration values,
wherein each cell in the table is associated with a remarketing list comprised of a plurality of user identifiers; and
a remote computing device having a memory module;
the first computing device configured to:
coalesce the matrix of remarketing lists into a series of logical remarketing lists by selecting the remarketing lists associated with one or more logical columns of the matrix of remarketing lists and combining the selected remarketing lists into a logical remarketing list comprised of the plurality of user identifiers from each of the selected remarketing lists; and
call an application programming interface (API) to transmit instructions to the remote computing device, wherein the instructions include a representation of the series of logical remarketing lists and a representation of the matrix of remarketing lists, and enable the remote computing device to replicate the series of logical remarketing lists and the matrix of remarketing lists in a memory module of the remote computing device,
wherein the remote computing device uses the instructions to adjust one or more bids.
